(19) United States
(12) Patent Application Publication
(10) Pub. No.: US 2008/0295946 A1
(43) Pub. Date: Dec. 4, 2008

(54) Pneumatic Vehicle Tire with Reinforced Tread

(75) Inventors: Martin Josef Kraus, Hannover (DE); Heinz-Bernhard Mazur, Wedemark (DE)

Correspondence Address: LERNER GREENBERG STEMER LLP, P O BOX 2480, HOLLYWOOD, FL, 33022-2480, US

(73) Assignee: CONTINENTAL AKTIENGESELLSCHAFT, Hannover (DE)

(21) Appl. No.: 12/188,484

(22) Filed: Aug. 8, 2008

Related U.S. Application Data
(63) Continuation of application No. PCT/EP2007/000569, filed on Jan. 24, 2007.

(30) Foreign Application Priority Data
Mar. 10, 2006 (DE) 10 2006 011 158.3

(51) Int. Cl. B60C 15/06

(52) U.S. Cl. 152/541

(57) ABSTRACT

A vehicle tire contains a tread part, a bead region which is radially formed inside the tread part and having a bead core, a bead filler formed radially outside the bead core, and a bead reinforcing layer extending over a periphery of the vehicle tire and containing at least one resistance carrier spirally wound radially outwardly from the inside towards the periphery. A further bead reinforcing strip is formed radially inside the bead core, the further bead reinforcing strip extending axially over the entire axial length of the bead core and being radially outwardly folded back towards the two axial outer sides of the bead core. The further bead reinforcing strip having a first folded-back section extending up to a radial extension height from a vertex of the wheel rim and a second folded-back section up to a radial extension height from the vertex X of the wheel rim.

### CROSS-REFERENCE TO RELATED APPLICATION

This is a continuing application, under 35 U.S.C. §120, of copending international application No. PCT/EP2007/000569, filed Jan. 24, 2007, which designated the United States; this application also claims the priority, under 35 U.S.C. § 119, of German patent application No. DE 10 2006 011 158.3, filed Mar. 10, 2006; the prior applications are herewith incorporated by reference in their entirety.

### BACKGROUND OF THE INVENTION

### Field of the Invention

The invention relates to a vehicle tire—in particular a pneumatic vehicle tire—with a tread rubber, with a bead region formed radially inside the tread rubber and with a bead core for securing the vehicle tire on a correspondingly formed seat of a rim—in particular with a bead filler formed radially outside the bead bore—and with a bead reinforcing ply, which is formed in the fastening region. The bead reinforcing ply extends over the circumference of the vehicle tire and is formed with at least one strengthening support, disposed such that it is wound in the circumferential direction, formed spirally from the inside outward in the radial sense.

Vehicle tires of this type are known for example from published, European patent EP 1 174 289 A2, corresponding to U.S. Pat. No. 6,776,207 B2 and from European patent EP 1 129 870 B1, corresponding to U.S. Pat. No. 6,543,502 B2. Although the way in which they are formed makes it possible to exploit greater advantages with respect to the high tensile strength in the circumferential direction in the region near the seat of the vehicle tire on the rim, whereby a very secure fit can be achieved, it is difficult to produce these vehicle tires with a bead reinforcing ply which, in the finished state of the tire, is arranged alongside the carcass turned back around the bead core in addition to the bead core and the bead filler and has at least one strengthening support arranged such that it is wound in the circumferential direction, formed spirally from the inside outward in the radial sense. Either the spiral winding must take place in the toroidally built-up green state or building up must take place with a conventional flat buildup on a building drum, the flatly wound-up bead reinforcing ply then also has to be raised up in the subsequent shaping of the green tire counter to the tensile forces of the strengthening supports. In both cases, there is the risk of separation of the bead core/bead filler and the bead reinforcer on the one hand and the bead reinforcer and the carcass on the other hand. The tensile forces, and resultant constrictions, also exert a load on the surrounding material, so that undesired shearing effects and possible instances of damage may also occur between the latter and the bead core. Therefore, increased effort is required to avoid damage or to prevent possibly damaged green tires from being vulcanized. In addition, in all loading states, the circumferentially wound strengthening supports of the bead reinforcing ply cut into the rubber material of the bead core with high tensile forces during the manufacture and operation of the vehicle tire. This requires great additional effort to reduce the risk of damage and to ensure that possibly damaged vehicle tires are identified and rejected. A possibly intended separation of the components that have fused together under these loads is scarcely possible either before or after vulcanization—and only then with great effort.

### SUMMARY OF THE INVENTION

It is accordingly an object of the invention to provide a pneumatic vehicle tire with a reinforced bead, which overcomes the above-mentioned disadvantages of the prior art devices of this general type, which provides by simple measures and with great reliability a vehicle tire.

The object is achieved according to the invention by forming a vehicle tire—in particular a pneumatic vehicle tire—with a tread rubber, with a bead region formed radially inside the tread rubber and with a bead core for securing the vehicle tire on a correspondingly formed seat of a rim—in particular with a bead filler formed radially outside the bead core—and with a bead reinforcing ply, which is formed in the fastening region. The bead reinforcing ply extends over a circumference of the vehicle tire and is formed with at least one strengthening support, disposed such that it is wound in the circumferential direction, formed spirally from the inside outward in the radial sense, in which there is formed radially inside the bead core at least one further bead reinforcing strip—in particular made to extend over the entire circumference of the vehicle tire—which further strip extends in the axial direction over the entire axial extent of the bead core and is respectively turned back radially outward on both axial outer sides of the bead core. A first turned-back portion extends to a height of radial extent H_{F1} from the vertex X of the rim and the second turned-back portion extending to a height of radial extent H_{F2} from the vertex X of the rim.

The bead core and the carcass can be protected by the bead reinforcing strip from undesirably high loads acting between the carcass and the bead core that may be induced by the tensile stresses of the bead reinforcing ply and the carcass. As a result, the bead region is better protected from undesired consequences of excessive tensile stresses of the strengthening supports of the bead reinforcing ply. Risks of damage caused by the high loading induced by the tensile stresses can be reduced in this way during both manufacture and operation of the vehicle tire.

It is particularly advantageous for the tire to be formed with both the height of radial extent H_{F1} from the vertex X of the rim and the height of radial extent H_{F2} from the vertex X of the rim being formed radially outside the radial distance of the radially outer extent of the bead core from the vertex X of the rim. This makes a complete, reliable protective effect possible right into the critical transitional region between the tire sidewall and the bead core.

It is particularly advantageous for the tire to be formed with the first turned-back portion being formed axially adjacent the bead reinforcing ply. This achieves the effect that the bead reinforcing strip very reliably absorbs undesired loads that are induced by very high tensile forces from the strengthening supports of the bead reinforcing ply into the adjacent bead regions and further reduces the risk of damage. This can be ensured particularly certainly and reliably by the tire being formed wherein the first turned-back portion is formed in direct contact with the bead reinforcing ply.

The tire is formed particularly advantageously with the first turned-back portion being formed in direct contact with the bead core, at least radially inside the bead core. This makes particularly reliable protection of the bead core possible while ensuring that force introduction into the bead core is made more uniform.

The tire is formed particularly advantageously with the first turned-back portion being formed in direct contact with the bead core and with the bead filler. This makes particularly reliable protection both of the bead core and of the core filler possible while ensuring that force introduction into the bead core is made more uniform.

The tire is formed particularly advantageously with the second turned-back portion being formed in direct contact with the bead core and with the bead filler. This makes particularly reliable protection both of the bead core and of the core filler possible while ensuring that force introduction into the core is made more uniform.

The tire is formed particularly advantageously with the first turned-back portion being disposed on the axial inner side of the bead core in the vehicle tire. This makes it possible in a simple way to obtain certain separation of the carcass from the bead core in this region of the bead and make the forces between the carcass and the bead core as well as between the bead reinforcing ply and the bead core more uniform. The lower bead region can be stiffened in a simple way to reduce the forces caused by the tire deflection and kinematic changes in this bead region.

The tire is formed particularly advantageously with the first turned-back portion being formed between the bead reinforcing ply and the bead core. The lower bead region can in this way be stiffened particularly easily and reliably to reduce the forces caused by the tire deflection and kinematic changes in this bead region. The forces in the lower bead region between the carcass and the bead reinforcing ply, between the carcass and the bead core and between the bead reinforcing ply and the bead core can be made more uniform directly or indirectly.

The tire is formed particularly advantageously with the bead reinforcing ply being formed between the first turned-back portion and the bead core. The lower bead region can in this way be stiffened particularly simply and reliably to reduce the forces caused by the tire deflection and kinematic changes in this bead region. The forces in the lower bead region between the carcass and the bead reinforcing ply, between the carcass and the bead core and between the bead reinforcing ply and the bead core can be made more uniform directly or indirectly.

The tire is formed particularly advantageously with the bead reinforcing ply being formed between the first turned-back portion of a first reinforcing strip and the first turned-back portion of a second reinforcing strip. As a result, the work performed in the strengthening support of the bead reinforcing ply is further reduced. In addition, the carcass can be permanently separated from the bead reinforcing ply. The two reinforcing strips act like a protective cap, which provide certain and protective separation of the reinforcing ply from the carcass and the core, possibly with a bead filler. As a result, maximum protection from “migrating” strengthening supports or elements of strengthening supports from the reinforcing ply is possible.

The tire is formed particularly advantageously with the further bead reinforcing strip being formed by a ply of strengthening supports—in particular textile strengthening supports—embedded in unvulcanized or vulcanized rubber. This makes a small layer thickness of the bead reinforcing strip possible and makes it possible to allow fabrication to be performed more easily and to reduce costs.

The tire is formed particularly advantageously with the strengthening supports being formed so as to extend at a helix angle of 35° to 55° in relation to the circumferential direction of the tire. This serves for obtaining a permanent separation of the components throughout the lifetime of the tire and for permanently making the forces introduced more uniform as the tire passes through its contact area with the ground.

The tire is formed particularly advantageously with the bead reinforcing ply being formed with at least one strengthening support arranged such that it is wound in the circumferential direction, formed spirally from the inside outward in the radial sense, the strengthening support being a strengthening support that is of a segmented form in the circumferential direction.

The tire is formed particularly advantageously with the bead reinforcing ply being formed with at least one strengthening support arranged such that it is wound in the circumferential direction, formed spirally from the inside outward in the radial sense, a strengthening support that is formed continuously and uninterruptedly in the circumferential direction being wound in a first, radially inner region of the extent of the reinforcing material and a strengthening support that is of a segmented form in the circumferential direction being wound in a second, radially outer region of the extent of the reinforcing material. This allows ease of fabrication to be improved and the cord spacing in the radially outer region of the reinforcing material to be made more uniform to ensure the certainty of obtaining a high quality standard.

The tire is formed particularly advantageously with the strengthening support of the bead reinforcing ply being a metallic strengthening support. This makes it possible for particularly high tensile forces to be accepted and made more uniform.

The tire is formed particularly advantageously with at least one carcass ply—in particular of a radial type of construction—being formed with parallel strengthening supports embedded in unvulcanized or vulcanized rubber material and wrapped around the bead core, the bead reinforcing strip also being arranged between the carcass ply and the bead core. The bead reinforcing strip protectively separates the bead core from the carcass even under the bead core in the region in which the tire is seated on the rim in the operating state.

The tire is formed particularly advantageously with the carcass extending radially inward with its main part in the tire sidewall between the tire shoulder and the radial inner side of the bead core and thereby formed in the radial region of extent of the bead core—and in particular of the bead filler—such that it extends along the axial inner side of the bead core—and in particular of the bead filler—and the carcass being formed with its turned-back portion along the axial outer side of the bead core—and in particular of the bead filler—such that it is made to extend radially outward.

The tire is formed particularly advantageously with the turned-back portion of the carcass ending on the surface of the bead filler at a distance greater than zero from the main part of the carcass. This allows the durability of the tire to be further improved.

The tire is formed particularly advantageously with the strengthening supports of the carcass ply being monofilaments or multifilaments of textile or metallic material—in particular of steel. This allows the respective tire-specific requirements to be met very individually by the tensile stress/elongation profile of the strengthening supports.

Other features which are considered as characteristic for the invention are set forth in the appended claims.

Although the invention is illustrated and described herein as embodied in a pneumatic vehicle tire with reinforced bead, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, cross-sectional representation of a pneumatic vehicle tire of a commercial vehicle for fifteen-degree tapered bead seat rims in a cross-sectional plane that contains the tire axis according to the invention;

FIG. 2 is an enlarged sectional representation of a radially inner sidewall region of the pneumatic vehicle tire from FIG. 1 in a fitted, non-loaded operating state on a fifteen-degree tapered bead seat rim;

FIG. 3 is a sectional representation of an alternative form of the radially inner sidewall region of a pneumatic vehicle tire with a two-part bead filler;

FIG. 4 is a sectional representation of an alternative form of the radially inner sidewall region represented in FIG. 2 of the pneumatic vehicle tire;

FIG. 5 is a sectional representation showing an alternative form of the radially inner sidewall region represented in FIG. 3 of the pneumatic vehicle tire;

FIG. 6 is a sectional representation showing a further alternative form of the radially inner sidewall region represented in FIG. 2 of the pneumatic vehicle tire;

FIG. 7 is a sectional representation showing an alternative form of the radially inner sidewall region represented in FIG. 3 of the pneumatic vehicle tire;

FIG. 8 is a sectional representation showing a further alternative form of the radially inner sidewall region represented in FIG. 2 of the pneumatic vehicle tire;

FIG. 9 is a sectional representation showing an alternative form of the radially inner sidewall region represented in FIG. 3 of the pneumatic vehicle tire;

FIG. 10 is a sectional representation showing a further alternative form of the radially inner sidewall region represented in FIG. 8 of the pneumatic vehicle tire;

FIG. 11 is a sectional representation showing an alternative form of the radially inner sidewall region represented in FIG. 9 of the pneumatic vehicle tire;

FIG. 12 is a sectional representation showing an alternative form of the radially inner sidewall region represented in FIG. 9 of the pneumatic vehicle tire;

FIG. 13 is a sectional representation showing an alternative form of the radially inner sidewall region represented in FIG. 2 of the pneumatic vehicle tire;

FIG. 14 is a sectional representation showing a further alternative form of the radially inner sidewall region represented in FIG. 13 of the pneumatic vehicle tire;

FIG. 15 is a sectional representation showing a further alternative form of the radially inner sidewall region represented in FIG. 14 of the pneumatic vehicle tire;

FIG. 16 is a cross-sectional representation of the pneumatic vehicle tire of the commercial vehicle for five-degree tapered bead seat rims in a cross-sectional plane that contains the tire axis;

FIG. 17 is an enlarged sectional representation of the radially inner sidewall region of the pneumatic vehicle tire from FIG. 16 in a fitted, non-loaded operating state on a five-degree tapered bead seat rim, by analogy with the exemplary embodiment represented in FIG. 2 of the pneumatic vehicle tire on a fifteen-degree tapered bead seat rim;

FIG. 18 is a sectional representation showing a further alternative form of the radially inner sidewall region represented in FIG. 17 of the pneumatic vehicle tire;

FIG. 19 is a sectional representation showing a further alternative form of the radially inner sidewall region of the pneumatic vehicle tire represented in FIG. 17;

FIG. 20A is a cross-sectional representation of a pneumatic vehicle tire for passenger cars with a well-base rim and a cross-sectional plane that contains the tire axis, by analogy with the exemplary embodiment represented in FIG. 2 of the pneumatic vehicle tire of the commercial vehicle on a fifteen-degree tapered bead seat rim;

FIG. 20B is an enlarged sectional representation showing a prefabricatable core component for the manufacture of the pneumatic vehicle tire from FIG. 20A;

FIG. 21A is a cross-sectional representation of a pneumatic vehicle tire for motorcycles or scooters with a well-base rim in a cross-sectional plane that contains the tire axis, by analogy with the exemplary embodiment represented in FIG. 2 of the pneumatic vehicle tire of a commercial vehicle on a fifteen-degree tapered bead seat rim;

FIG. 21B is an enlarged sectional representation showing a prefabricatable core component for the manufacture of the pneumatic vehicle tire from FIG. 21A.

### DETAILED DESCRIPTION OF THE INVENTION

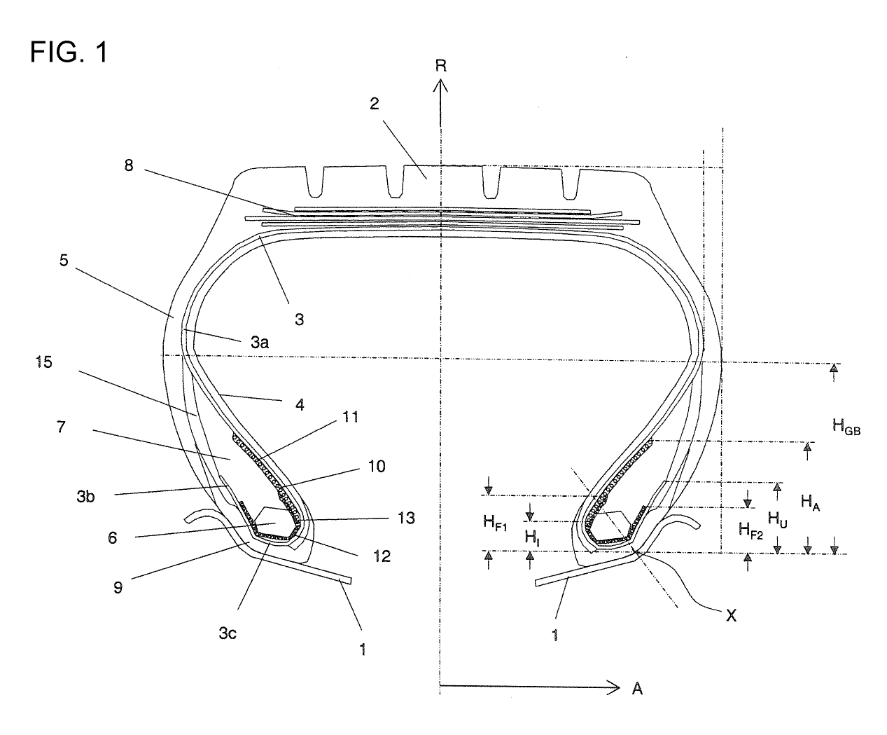

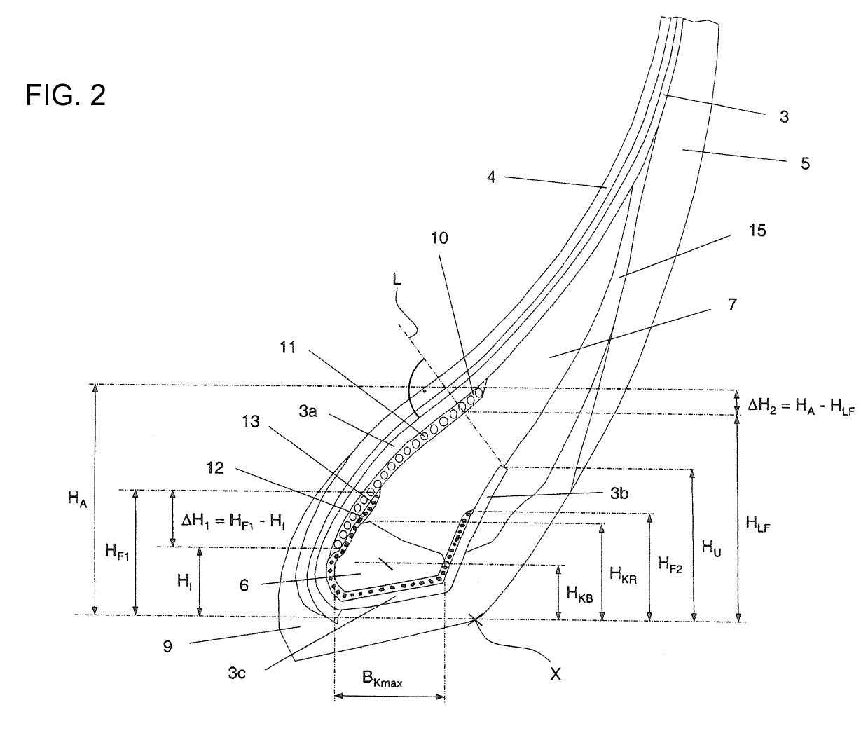

Referring now to the figures of the drawing in detail and first, particularly, to FIGS. 1 and 2 thereof, there is shown a pneumatic tire of a commercial vehicle fitted on a corresponding rim in a non-loaded operating state. For the purposes of simplification, the corresponding rim is not represented in FIG. 2.

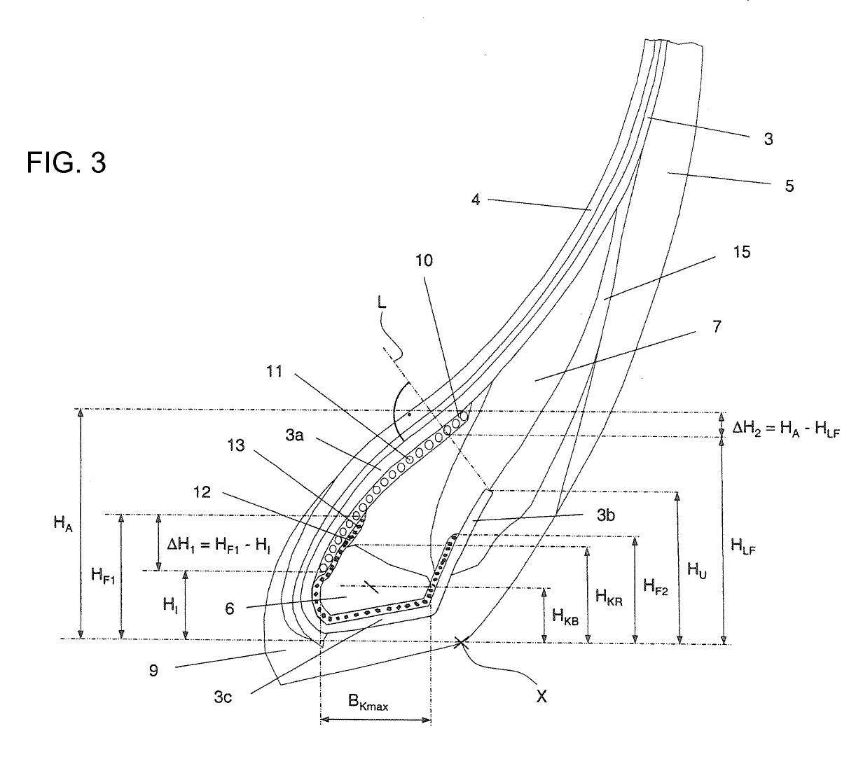

FIG. 1 schematically shows the pneumatic tire of a commercial vehicle in cross section, a fifteen-degree tapered bead seat rim, which has an inclination of the rim shoulder or bead seat from axial A of 15° and a well base, is also indicated in the bead region. A tread rubber 2, a carcass inlay 3, a multi-ply breaker belt 8, an inner layer 4, in particular a double-ply inner layer 4, two sidewalls 5 and a bead core 6 on each sidewall, a bead filler (also known as an apex) 7, a bead strip 9 and an additional rubber profile 15, formed as an outer bead profile, between the sidewall 5 and the bead filler 7 are represented as some of the components of the pneumatic tire of a commercial vehicle. The carcass inlay 3 contains, in particular, steel cords as strengthening supports, which extend at right angles or substantially at right angles to the circumferential direction of the tire, and consequently in a radial direction R of the tire. The bead core 6 contains steel cords, the core profile 7, arranged radially outside the bead core 6 and seated on the latter, is formed of a rubber mixture with a high modulus of elasticity and may also be embodied in a multi-part form—as represented for example in FIG. 3—and consequently is formed of rubber mixtures of different moduli of elasticity.

As represented in FIG. 2, the carcass inlay 3 extends with its main part 3a from the breaker belt radially inward through the sidewall along the axially inner side of the bead filler 7 and the bead core 6, is led axially outward around the bead core 6 to form an intermediate portion 3c on the radially inner side of the bead core 6 and wrapped radially outward around the bead core 6, and extends with its turned-back portion 3b on the axial outer side of the bead core 6 and of the bead filler 7 in direct contact with the bead filler 7 to a radial distance H_{U} from a vertex X of the rim.

On the axial inner side of the bead filler 7, a bead reinforcing ply 10 is formed between the bead filler 7 and the main part 3a the carcass 3. The bead reinforcing ply 10 extends in this case from a radially inner position at the radial distance H_{I} from the vertex X of the rim to a radially outer position at the radial distance H_{A} from the vertex X of the rim. The bead reinforcing ply 10 is formed by a continuous strengthening support 11, which is made to extend in the circumferential direction over the entire tire, is embedded in a rubber mixture and wound up spirally so as to extend from the inside in a radial sense, beginning at the radial height H_{I}, radially outward to the radial height H_{A}. The bead reinforcing ply 10 is in this case in direct contact along its radial extent with the main part 3a of the carcass inlay 3.

The dimension H_{I} is governed by: H_{KB}≦H_{I}≦H_{KR}, where H_{KB} indicates the radial distance from the vertex X of the rim at which the bead core 6 has its maximum width B_{KMax}, measured in the axial direction of the pneumatic vehicle tire, and H_{KR} is the radial distance of the vertex X of the rim that corresponds to the maximum radial distance of the radially outer lateral surface area of the bead core 6 from the vertex X of the rim.

In an exemplary embodiment that is typical of pneumatic vehicle tires of commercial vehicles with a fifteen-degree bead seat, H_{U} is chosen to be equal to 35 mm and H_{KR} is chosen in the range 9.0 mm≦H_{KR}≦28.0 mm.

Also indicated in FIG. 1 is the radial distance H_{GB} from the vertex X of the rim that forms the widest point of the fitted pneumatic tire of a commercial vehicle in the operating state.

Depicted in FIG. 2 is the perpendicular L to the main part of the carcass 3a that, in the sectional planes represented, touches the end of the ply of the turned-back carcass portion 3b of the carcass inlay 3 at the radial distance H_{U} from the vertex X of the rim. The point of intersection (foot) of this perpendicular L to the main part of the carcass 3a is at a radial distance H_{LF} from the vertex X of the rim. The bead reinforcing ply 10 extends radially outward to the radial distance H_{A} from the vertex X of the rim, where H_{A} is governed by: (0.65 H_{LF})≦H_{A}≦(1.5 H_{LF}).

The bead outer profile 15 extends from a radial position at a radial distance from the vertex X of the rim that is less than the distance H_{U} to a radial position at a radial distance from the vertex X of the rim that is greater than the distance H_{A}.

As represented in FIGS. 1 and 2, formed radially inside the bead core 6 is at least one further bead reinforcing strip 12, which is made to extend over the entire circumference of the vehicle tire, made to extend in the axial direction of the entire axial extent of the bead core 6 and, on both axial outer sides of the bead core 6, wrapped around it, radially outward in each case, a first turned-back portion being made to extend to a height of radial extent H_{F1} from the vertex X of the rim and a second turned-back portion being made to extend to a height of radial extent H_{F2} from the vertex X of the rim. The bead reinforcing strip 12 is in this case formed so as to extend with its first turned-back portion in the radially inner region of the bead reinforcing ply 10 from the height of radial extent H_{F1} from the vertex X of the rim between the bead reinforcing ply 10 and the bead filler 7, in direct contact with the bead filler 7 and with the bead reinforcing ply 10, formed on the radially inner side of the bead core 6 so as to be placed snugly around the bead core 6, in direct contact with the bead core 6, and formed on the axial outer side of the bead core so as to extend radially outward to the height of radial extent H_{F2} from the vertex X of the rim between the turned-back carcass portion 3b and the bead filler 7, in direct contact with the turned-back carcass portion 3b and with the bead filler 7. The bead reinforcing strip 12 is formed by textile strengthening supports 13 of a known type, for example by one or more plies of textile cords arranged parallel to one another and containing monofilaments or multifilaments embedded in unvulcanized rubber or in vulcanized rubber. For example, the textile strengthening supports are formed by a multifilamentary cord of the construction 940×2 of polyamide, polyester or polyolefin of a known type. The strengthening supports 13 are in this case formed so as to extend at a helix angle of 35° to 55° in relation to the circumferential direction of the tire.

In an alternative embodiment, the bead reinforcing strip 12 is formed by a woven fabric of textile cords 13 coated with unvulcanized or vulcanized rubber, for example by a cross-woven fabric with linen, twill or atlas weave of a known type.

The height of radial extent H_{F1} from the vertex X of the first turned-back portion and the height of radial extent H_{F2} from the vertex X of the second turned-back portion are governed by: H_{F1}>H_{I}, H_{F1}<H_{A} and H_{F2}<H_{U}. For example, H_{F2} is formed such that (10.0 mm)≦H_{F2}≦(30.0 mm).

In an exemplary embodiment, a difference ΔH₁ between H_{F1} and H_{I}, which represents the dimension of the overlap of the bead reinforcing ply 10 and the bead reinforcing strip 12, is chosen such that ΔH₁=(H_{F1}−H_{I}) is governed by: (5 mm)≦ΔH₁≦(45 mm). In the exemplary embodiments represented, ΔH₁ is chosen for example to be equal to 15 mm.

In the exemplary embodiment represented, the height of radial extent H_{F1} of the additional reinforcing strip 12 on the axial inner side of the bead core 6 in the pneumatic vehicle tire is chosen to be greater than the height of radial extent H_{F2} from the vertex X of the rim on the axial outer side of the bead core 6. In this case, H_{KR}<H_{F2}<H_{U} and H_{F2}>H_{I}. For example, H_{F1} is chosen to be ≧H_{F2}.

FIG. 3 shows an alternative form of the pneumatic vehicle tire of the commercial vehicle that is formed in such a way, for use on a fifteen-degree tapered bead seat rim, in the fitted and non-loaded state on a correspondingly formed fifteen-degree tapered bead seat rim of a known type. The form corresponds to the embodiment represented in FIG. 2, but unlike in FIG. 2 the bead filler 7 is formed in a multi-part manner, containing at least two rubber mixtures of different moduli of elasticity. In the exemplary embodiment represented, the bead filler is formed in two parts from two rubber mixtures of different moduli of elasticity.

In the exemplary embodiments represented, the strengthening support 11 is a rubber-covered monofilamentary or multifilamentary steel cord, which is twisted or braided. In one embodiment, the cord 11 of the bead reinforcing ply 10 is a cord of the construction (2+6) or (3+7) or (3+9), which in one embodiment is coiled or wrapped around with a coil.

In the exemplary embodiments represented, the radial extent H_{A} lies radially inside the radially outer maximum extent of the bead filler 7.

In one exemplary embodiment, H_{I} is chosen for example to be from 10 to 25 mm. In the exemplary embodiments represented, H_{I} is chosen for example to be equal to 15 mm.

In one exemplary embodiment, the difference ΔH₂ between H_{A} and H_{LF} is chosen such that ΔH₂=(H_{A}−H_{LF}) is governed by: (−15 mm)≦ΔH₂≦(+23 mm). In the exemplary embodiments represented, ΔH₂ is chosen for example to be equal to 7 mm.

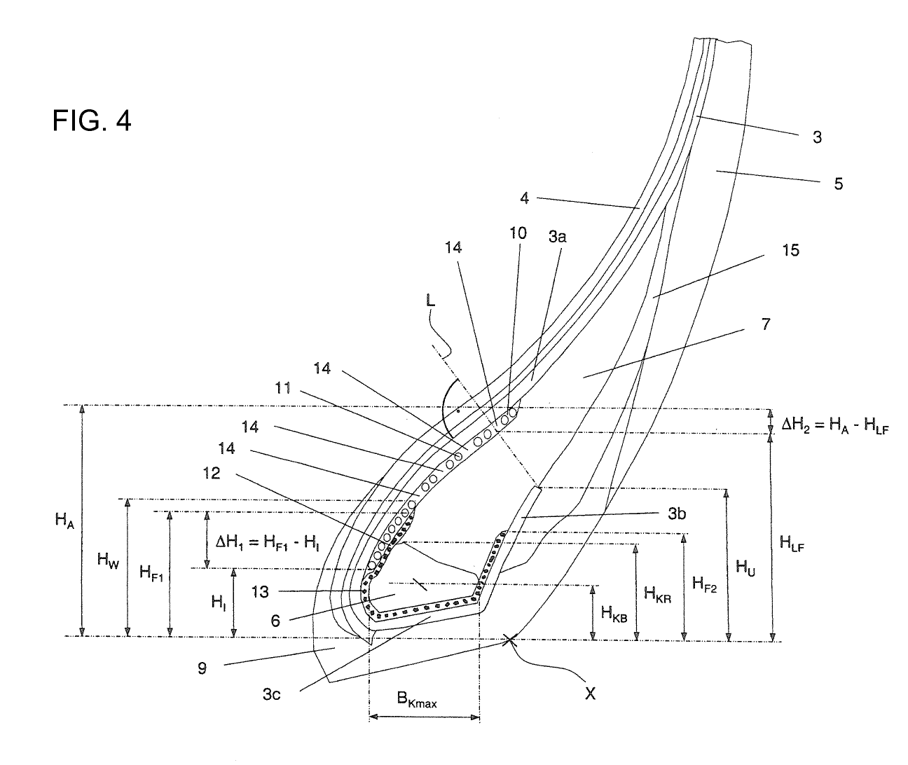

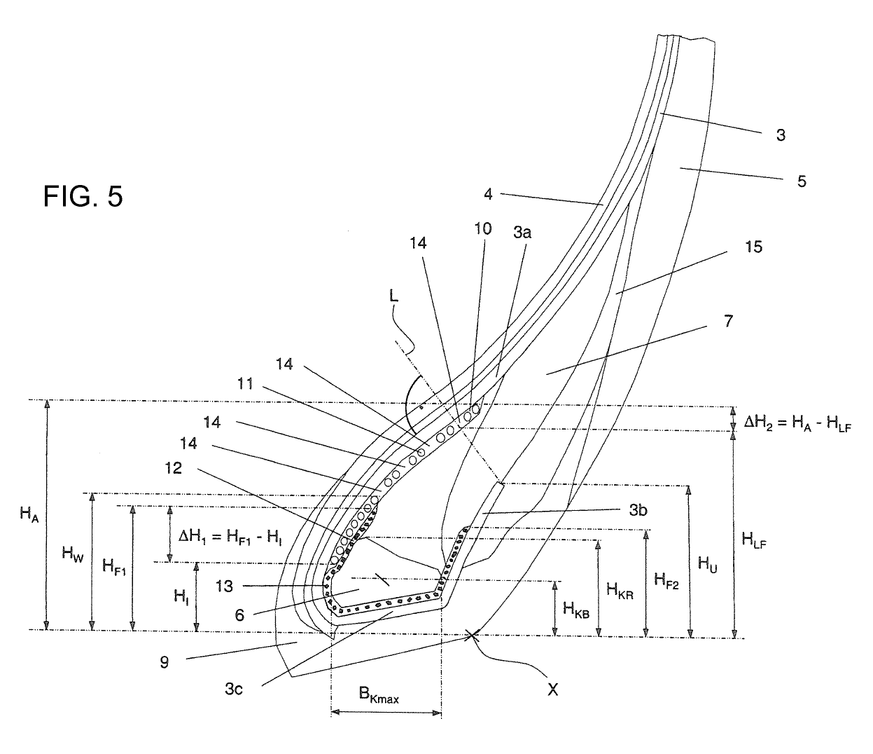

FIG. 4 shows an embodiment as an alternative to the embodiment represented by the example in FIG. 2, and FIG. 5 shows an embodiment as an alternative to the embodiment represented by the example in FIG. 3 the embodiments of FIG. 4 and FIG. 5 only being amended with respect to the embodiments of FIG. 2 and FIG. 3 with regard to the bead reinforcing ply 10. In these exemplary embodiments, the bead reinforcing ply 10 is formed by a radially inner region of extent, reaching from the radially inner position of extent of the bead reinforcing ply 10 at the radial distance H_{I} from the vertex X of the rim to a radial distance H_{W} from the vertex X of the rim with a strengthening support 11 wound continuously in it, spirally from the inside outward in the radial sense. In a radially outer region of extent that extends radially between the position at the radial distance H_{W} from the vertex X of the rim and the radially outer position of extent of the bead reinforcing ply 10 at the radial distance H_{A} from the vertex X of the rim, the strengthening support 11 is of a segmented form at regular intervals in the circumferential direction of the tire. In the circumferential direction of the tire, this produces a circumferential gap 14 respectively between the end of one circumferential segment and the beginning of the next circumferential segment. The segmenting is chosen here such that the circumferential gap 14 is bridged by a strengthening support segment of the next turn.

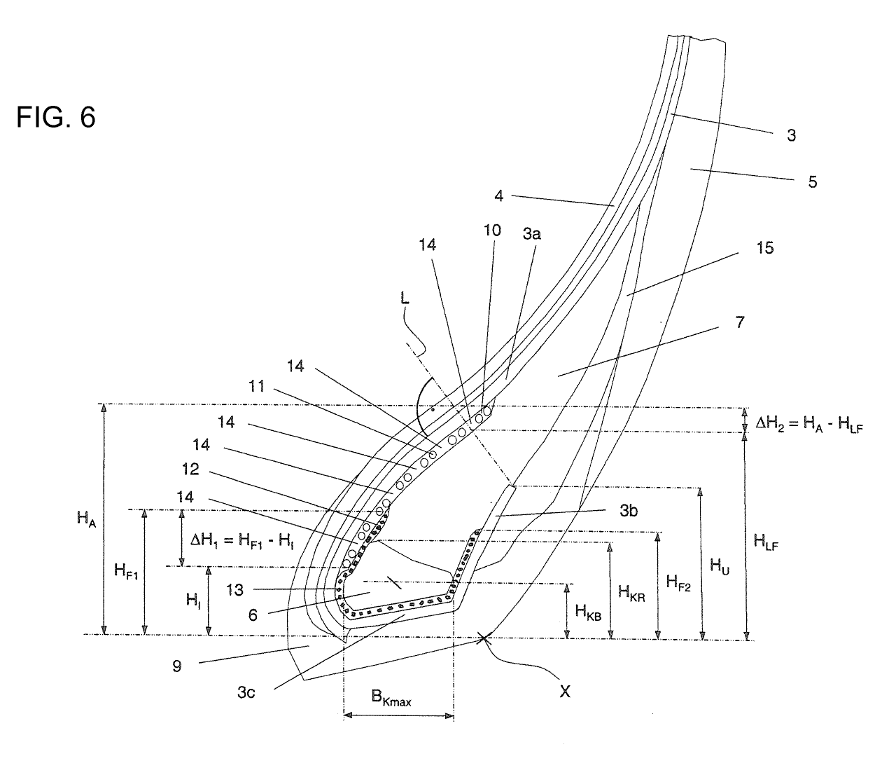

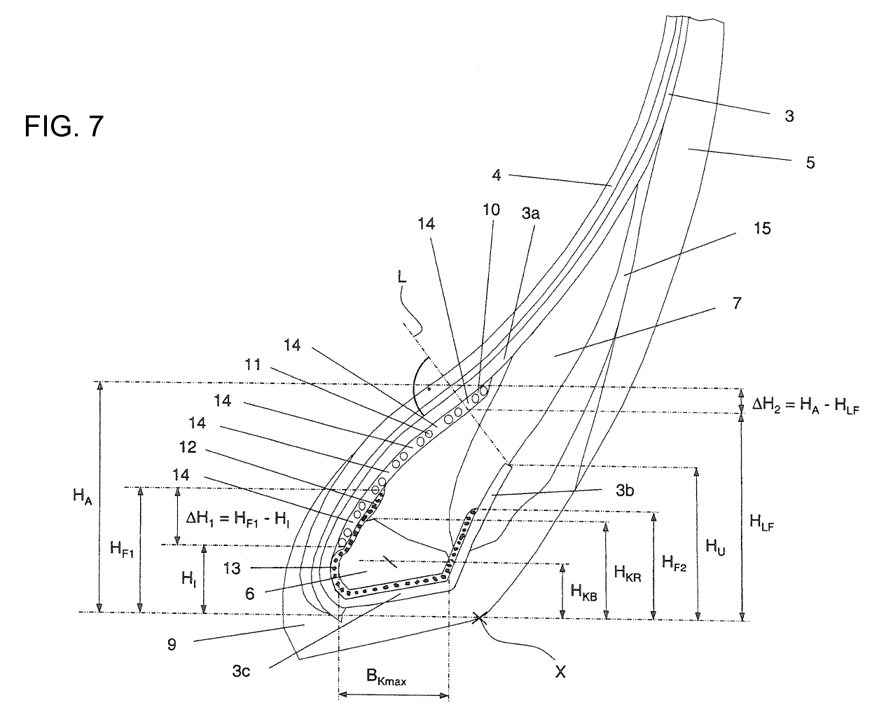

Represented in each of FIGS. 6 and 7 is an embodiment formed as an alternative to the embodiment represented in FIGS. 4 and 5, respectively, in which however the strengthening support 11 of the bead reinforcing ply 10 is in each case of a segmented form in the entire region of radial extent of the bead reinforcing ply 10.

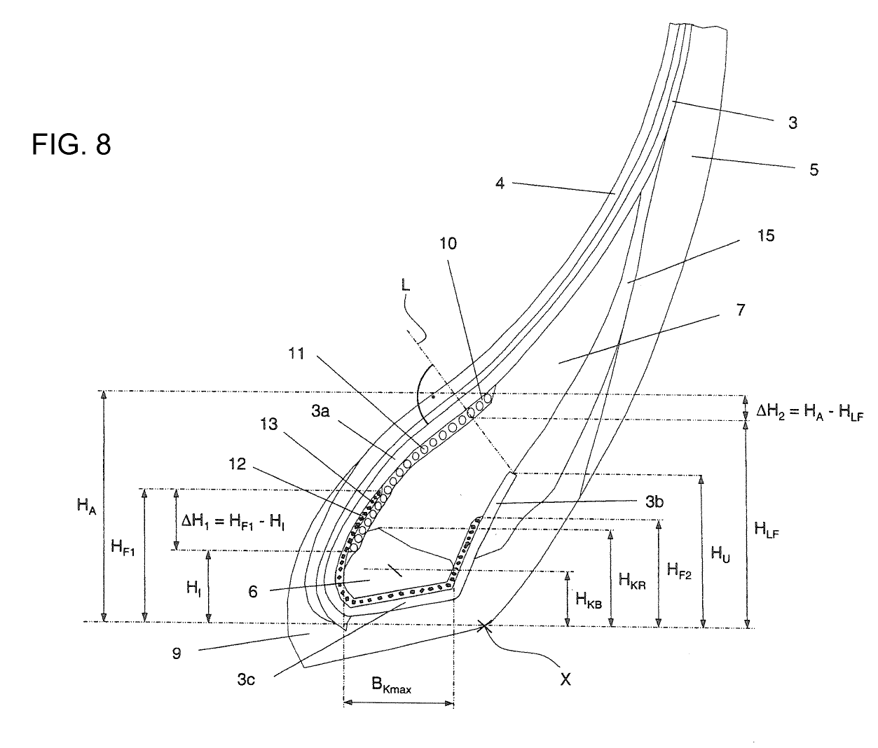

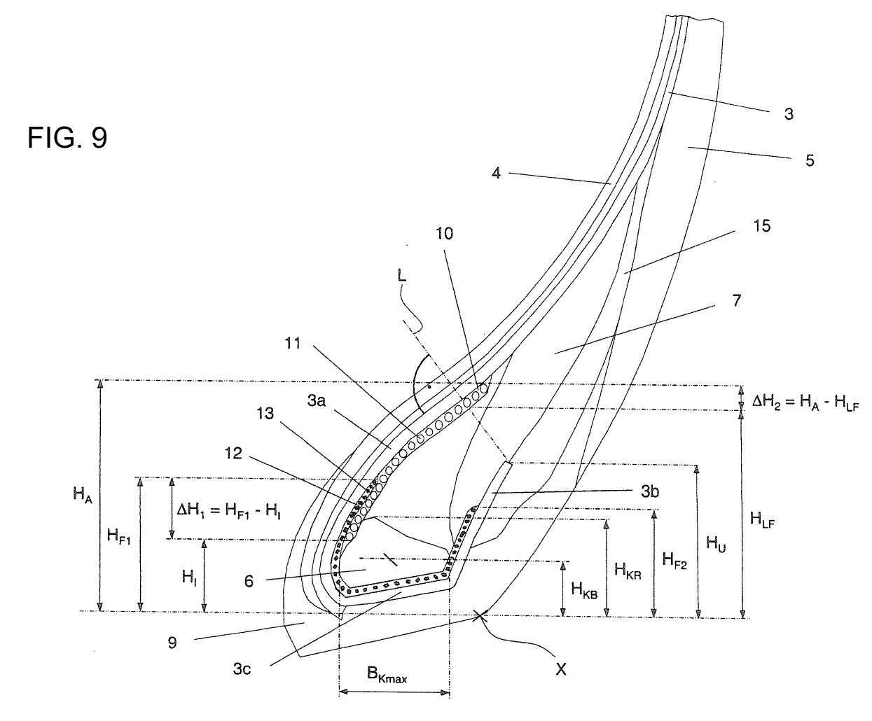

FIG. 8 shows an embodiment as a further alternative to the embodiment represented by the example in FIG. 2, and FIG. 9 shows an embodiment as an alternative to the embodiment represented by the example in FIG. 3, the bead reinforcing strip 12 in this case being formed so as to extend with its first turned-back portion in the radially inner region of the bead reinforcing ply 10 from the height of radial extent H_{F1} from the vertex X of the rim between the bead reinforcing ply 10 and the main part 3a of the carcass 3, in direct contact with the main part 3a of the carcass 3 and with the bead reinforcing ply 10, and formed radially inside the height of radial extent H_{I} from the vertex X of the rim in direct contact with the main part 3a of the carcass 3 and with the bead core 6, formed on the radially inner side of the bead core 6 so as to be placed snugly around the bead core 6, in direct contact with the bead core 6, and formed on the axial outer side of the bead core so as to extend radially outward to the height of radial extent H_{F2} from the vertex X of the rim between the turned-back carcass portion 3b and the bead filler 7, in direct contact with the turned-back carcass portion 3b and with the bead filler 7.

In a further embodiment, this form is also possible in conjunction with the other embodiments presented or described, for example in conjunction with the embodiments represented in FIG. 4 or FIG. 5.

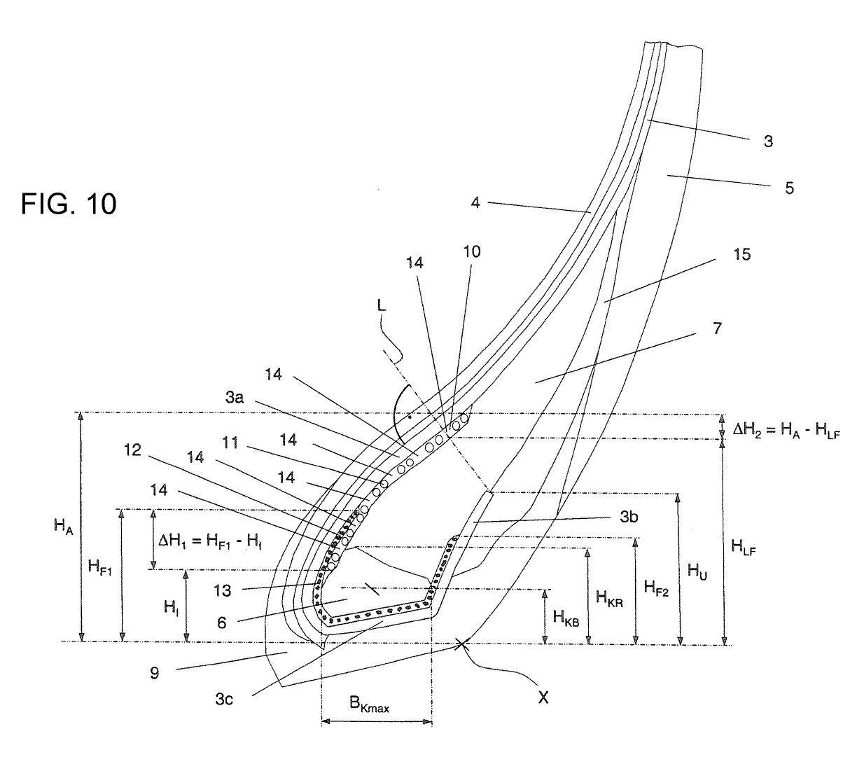

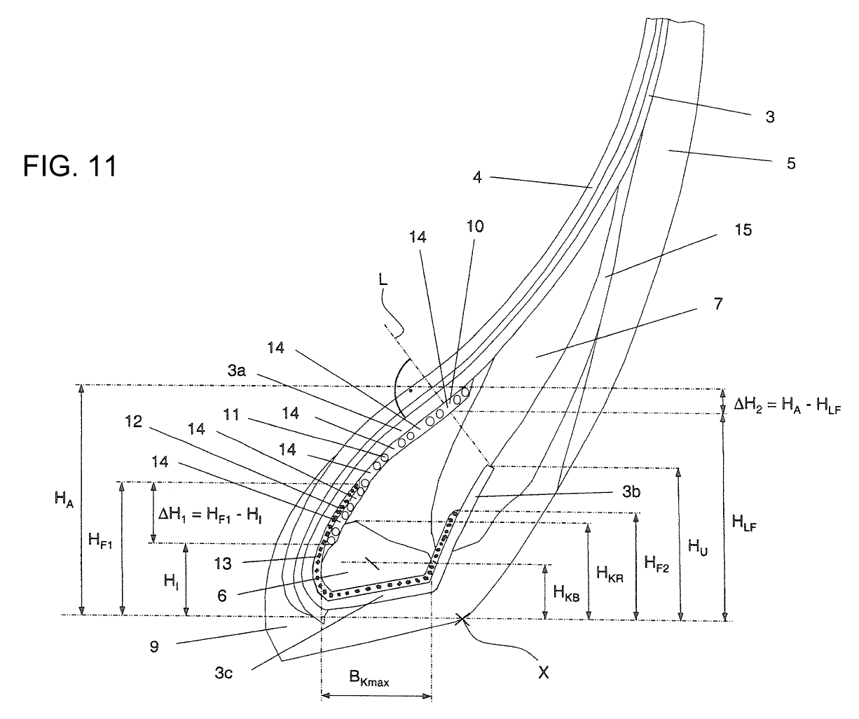

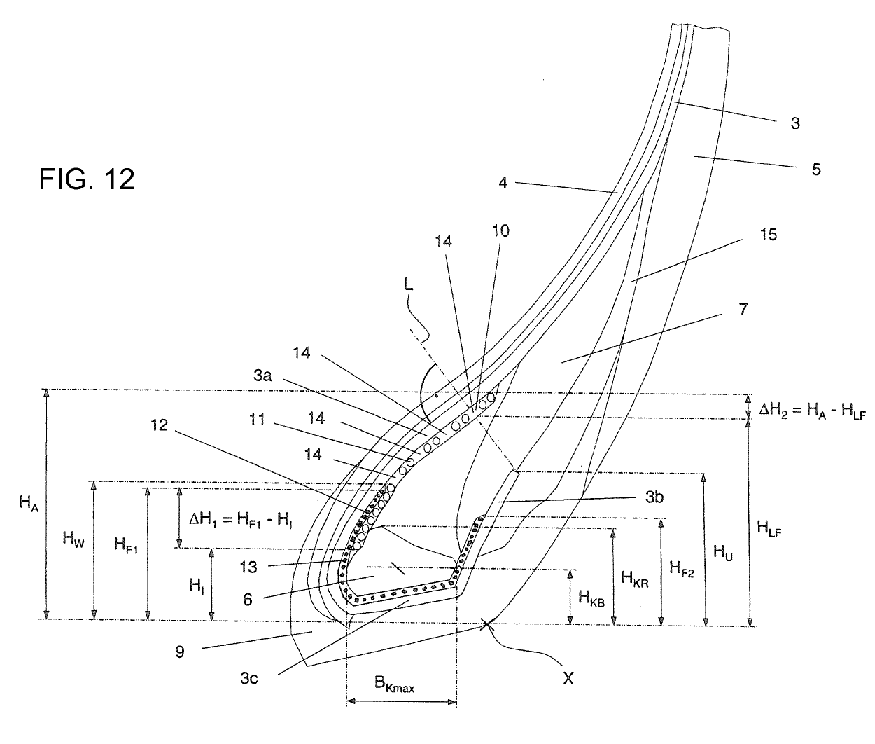

Represented in each of FIGS. 10 and 11 is an embodiment formed as an alternative to an embodiment represented in FIGS. 8 and 9, respectively, in which however the strengthening support 11 of the bead reinforcing ply 10 is in each case of a segmented form in the entire region of radial extent of the bead reinforcing ply 10. FIG. 12 shows such an embodiment that is formed by analogy with the embodiment represented in FIG. 5 with a bead reinforcing ply 10, the strengthening support 11 of which is formed continuously only in the radially inner region of extent and is of a segmented form in the radially outer region of extent.

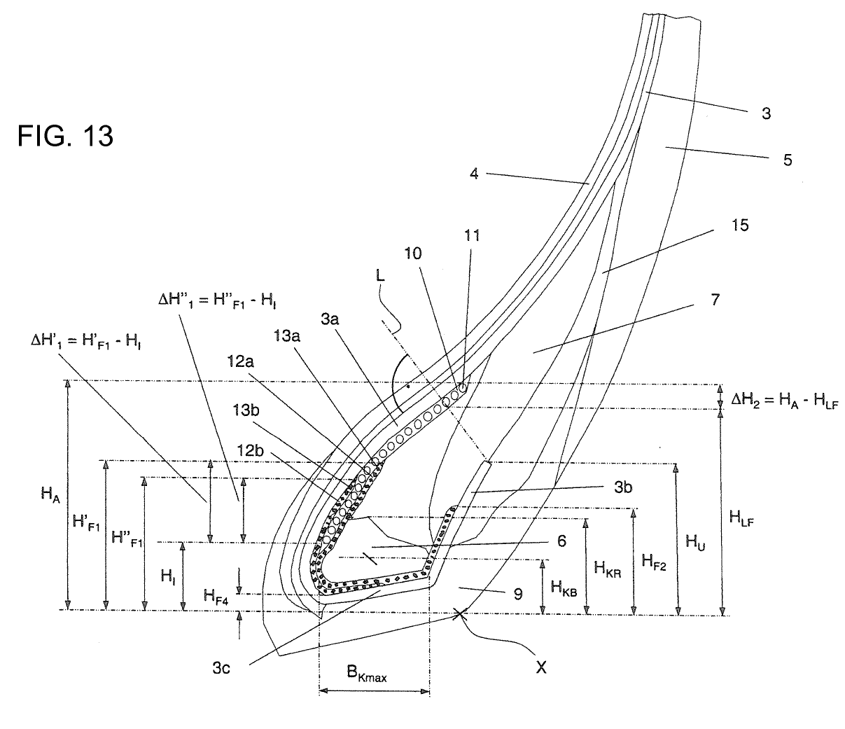

FIG. 13 shows a further embodiment, which is suitable in particular for heavy duty tires, as an alternative to the embodiment represented by the example in FIG. 2, the bead reinforcing strip 12 containing an inner ply 12a and an outer ply 12b. The first turned-back portion of the inner ply 12a extends to a height of radial extent H′_{F1} from the vertex X of the rim and the second turned-back portion extends to a height of radial extent H_{F2} from the vertex X of the rim. The inner ply 12a of the bead reinforcing strip 12 is in this case formed so as to extend with its first turned-back portion in the radially inner region of the bead reinforcing ply 10 from the height of radial extent H′_{F1} from the vertex X of the rim between the bead reinforcing ply 10 and the bead filler 7, in direct contact with the bead filler 7 and with the bead reinforcing ply 10, formed on the radially inner side of the bead core 6 in direct contact with the bead core 6 so as to be placed snugly around the bead core 6, and formed on the axial outer side of the bead core so as to extend radially outward to the height of radial extent H_{F2} from the vertex X of the rim between the turned-back carcass portion 3b and the bead filler 7, in direct contact with the turned-back carcass portion 3b and with the bead filler 7. The outer ply 12b of the bead reinforcing strip 12 is made to extend with its first turned-back portion in the radially inner region of the bead reinforcing ply 10 from the height of radial extent H″_{F1} from the vertex X of the rim between the bead reinforcing ply 10 and the main part 3a of the carcass 3, in direct contact with the main part 3a of the carcass 3 and with the bead reinforcing ply 10, and radially inside the height of radial extent H_{I} from the vertex X in direct contact with the main part 3a of the carcass 3 and with the inner ply 12a of the bead reinforcing strip 12. In one embodiment—represented in FIG. 13—the outer ply 12b ends on the radially inner side of the bead core 6 on the radially inner ply 12a. In a further non-illustrated embodiment, the radially outer ply 12b extends in direct contact with the radially inner ply 12a such that it is placed snugly around the bead core 6 and on the axial outer side of the bead core extends radially outward, for example to the height of radial extent H_{F2} from the vertex X of the rim, between the turned-back carcass portion 3b and the radially inner ply 12a, in direct contact with the turned-back carcass portion 3b and with the radially inner ply 12a.

The height of radial extent H′_{F1} from the vertex X of the rim of the first turned-back portion of the inner ply 12a, and also the height of radial extent H″_{F1} from the vertex X of the rim of the first turned-back portion of the outer ply 12b are in this case chosen such that: 0 mm≦(H′_{F1}−H″_{F1})≦11 mm.

The strengthening supports 13a of the inner ply 12a and the strengthening supports 13b of the outer ply 12b are formed so as to extend at a helix angle of 35° to 55° in relation to the circumferential direction of the tire. In an exemplary embodiment, the strengthening supports 13a of the inner ply 12a are in this case formed with a helical progression in relation to the circumferential direction U that is directed oppositely in the circumferential direction U of the vehicle tire than that of the strengthening supports 13b of the outer ply 12b. In another embodiment, the strengthening supports 13a of the inner ply 12a are in this case formed with a helical progression in relation to the circumferential direction U that is directed identically in the circumferential direction U of the vehicle tire to that of the strengthening supports 13b of the outer ply 12b.

In addition, the aforementioned particulars for the dimensioning and the material also apply here.

Even if not represented by further figures, these forms are respectively also formed in further exemplary embodiments in conjunction with embodiments already represented or described further above, for example in conjunction with a two-part core filler and/or in conjunction with a bead reinforcing ply 10 with a partly segmented strengthening support 11, as presented and described in connection with the embodiments relating to FIG. 3 to FIG. 12.

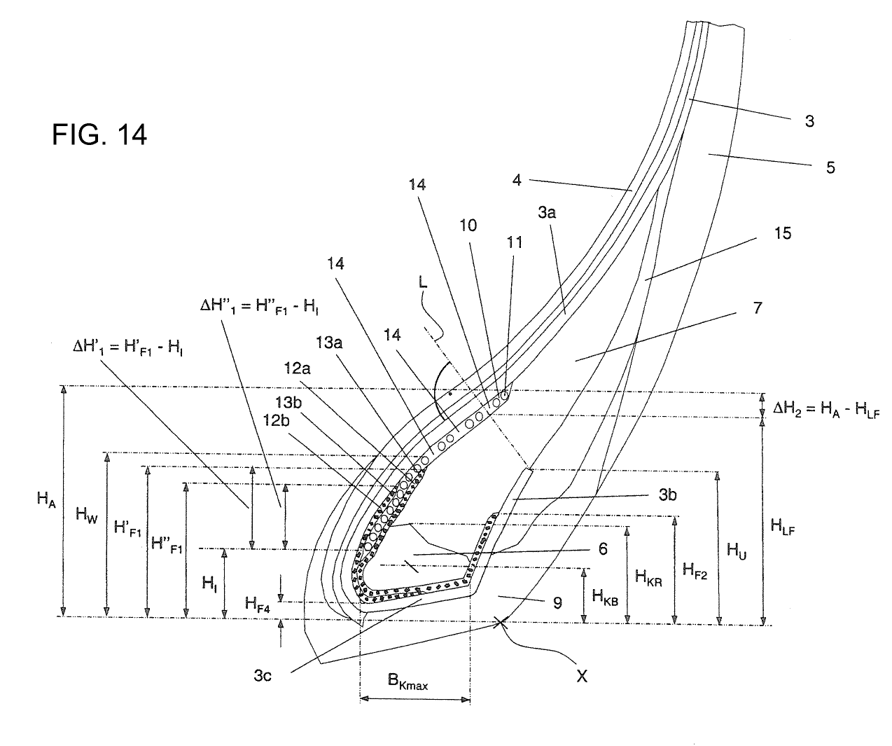

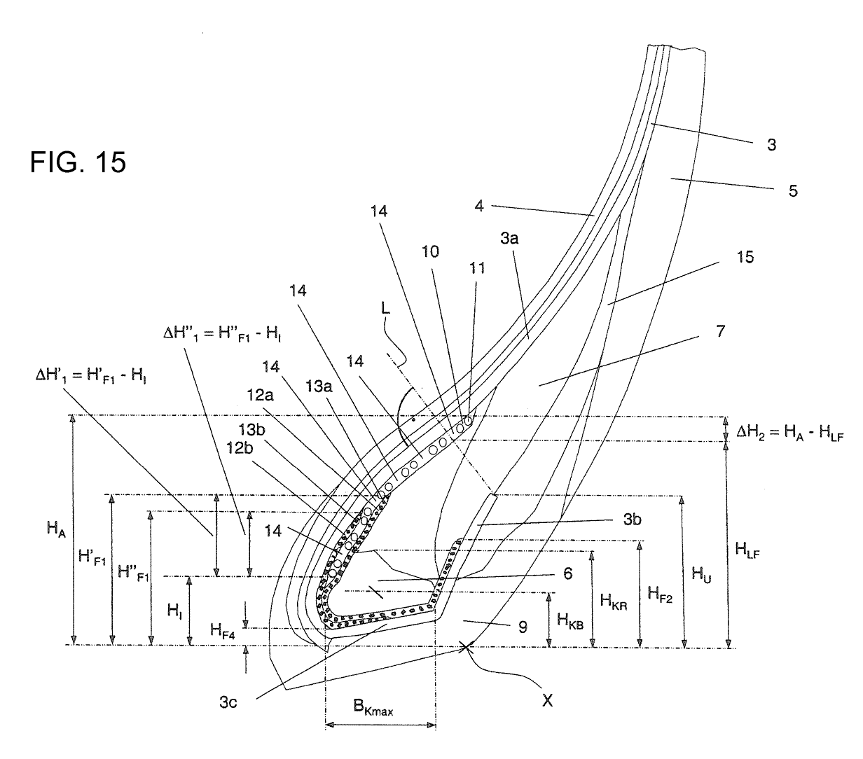

Represented in FIG. 15, for example, is an embodiment in which the strengthening support 11 of the bead reinforcing ply 10 is in each case of a segmented form in the entire region of radial extent of the bead reinforcing ply 10. FIG. 14 shows such an embodiment in which the strengthening support 11 of the bead reinforcing ply 10 is formed continuously only in the radially inner region of extent and is of a segmented form in the radially outer region of extent.

Even if the exemplary embodiments presented above have been respectively represented in FIGS. 1 to 15 on the basis of pneumatic tires of a commercial vehicle with a fifteen-degree tapered bead seat rim, all these embodiments are also formed in the case of pneumatic tires of a commercial vehicle with a five-degree tapered bead seat rim in further analogous embodiments.

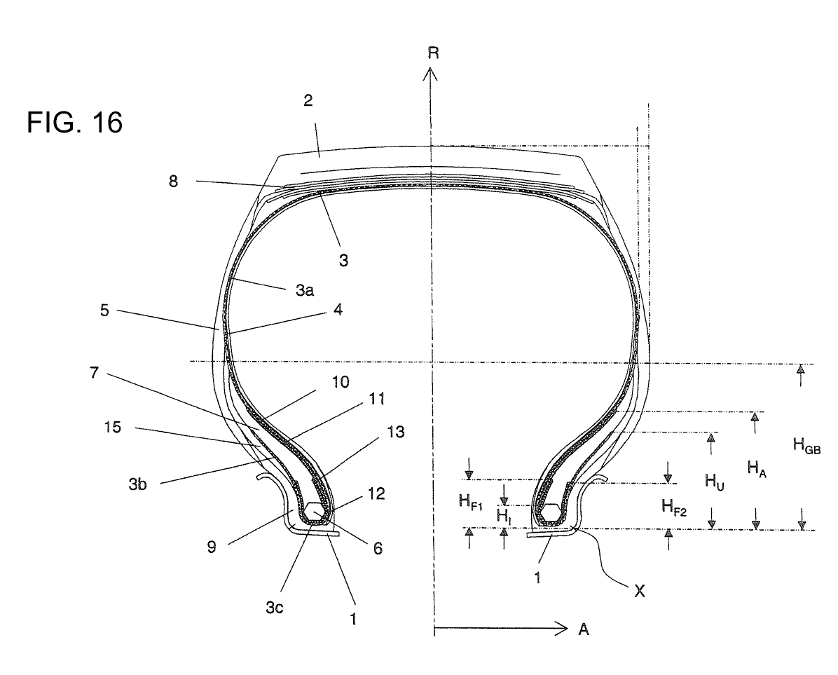

FIGS. 16 to 19 respectively show a pneumatic tire of a commercial vehicle of this type for a five-degree tapered bead seat rim in a non-loaded operating state, fitted on a corresponding rim.

FIG. 16 schematically shows the pneumatic tire of a commercial vehicle in cross section, a five-degree tapered bead seat rim that has an inclination of the rim shoulder or bead seat to the axial A of 5° and a flat base also being indicated in the bead region. The designations of the components and the designations of the dimensions are identical here to those in FIG. 1. The basic construction of the tire of a commercial vehicle corresponds to the construction already explained in connection with FIGS. 1 to 15 and the various exemplary embodiments presented in connection therewith.

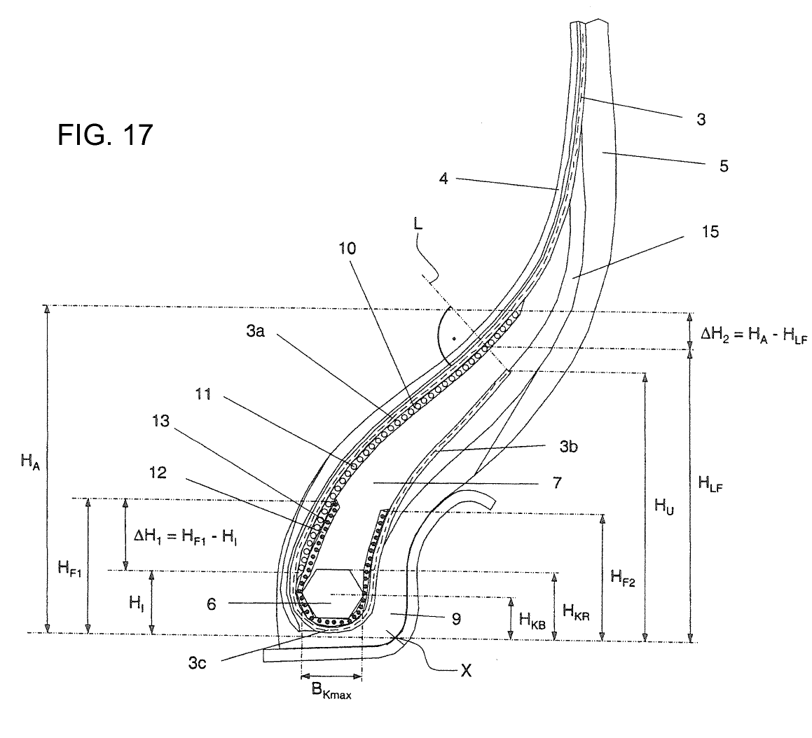

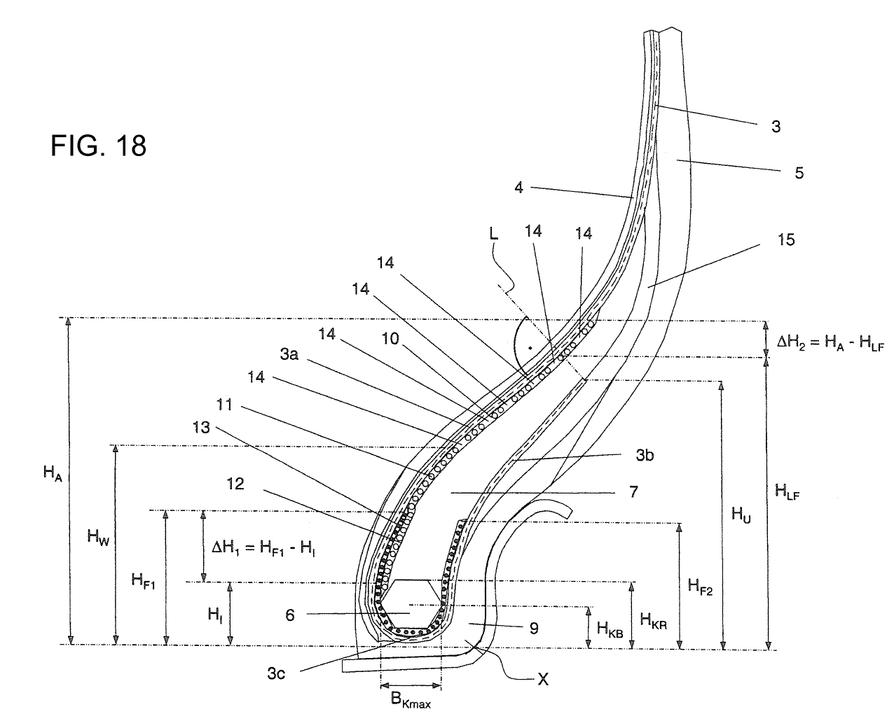

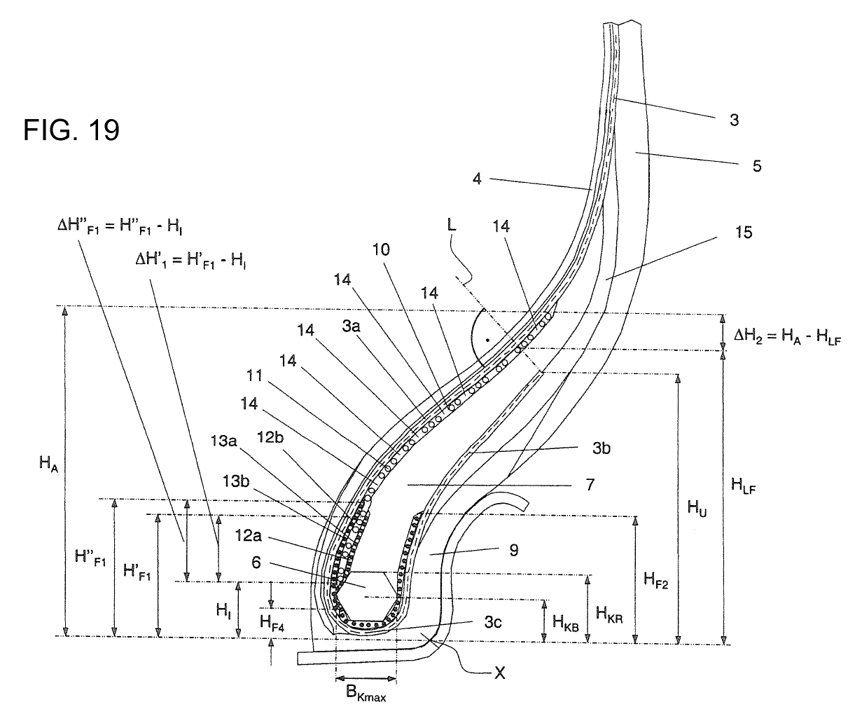

Instead of the one-part bead fillers represented in FIGS. 16 to 19, in other embodiments—not represented—a multi-part bead filler, for example a two-part bead filler, is used. Instead of the form represented in FIG. 17 with a bead reinforcing ply 10 with a continuously wound strengthening support 11, in the embodiment represented in FIG. 18 a bead reinforcing ply 10 with a strengthening support 11 wound continuously in the radially inner region of extent and in a segmented form in the radially outer region of extent, with circumferential gaps 14, is used in a way analogous to the explanations relating to FIG. 4, and in the embodiment represented in FIG. 19 a bead reinforcing ply 10 with a strengthening support 11 wound in a segmented form over its entire radial region of extent, with circumferential gaps 14, is used in a way analogous to the explanations relating to FIG. 6.

In an exemplary embodiment that is typical of pneumatic vehicle tires of commercial vehicles with a five-degree bead seat, the radial distance Hu from the vertex X of the rim to which the turned-back portion 3b of the carcass extends is chosen to be greater than in the case of a pneumatic vehicle tire of commercial vehicles with a five-degree bead seat. In an exemplary embodiment that is typical of pneumatic vehicle tires of commercial vehicles with a five-degree bead seat, H_{U} is chosen for example such that: 45 mm≦H_{U}≦75 mm.

As can be seen by way of example in FIG. 17, in the exemplary embodiment represented as analogous to FIG. 2, here too the bead reinforcing ply 10 extends radially outward to the radial distance H_{A} from the vertex X of the rim, where in the case of a pneumatic vehicle tire of a commercial vehicle with a five-degree bead seat H_{A} is governed by:

(0.65H_{LF})≦H_{A}≦(1.3H_{LF}).

In an exemplary embodiment of a pneumatic vehicle tire of a commercial vehicle with a five-degree bead seat, the difference ΔH₁ between H_{F1} and H_{I}, which represents the dimension of the overlap of the bead reinforcing ply 10 and the bead reinforcing strip 12, is chosen such that ΔH₁=(H_{F1}−H_{I}) is governed by: (5 mm)≦ΔH₁≦(32 mm). In the exemplary embodiments represented, ΔH₁ is chosen for example to be equal to 20 mm.

In an exemplary embodiment of a pneumatic vehicle tire of a commercial vehicle with a five-degree bead seat, the difference ΔH₂ between H_{A} and H_{LF} is chosen such that ΔH₂=(H_{A}−H_{LF}) is governed by: (−22 mm)≦ΔH₂≦(+22 mm). In the exemplary embodiments represented, ΔH₂ is chosen for example to be equal to 12 mm.

In an exemplary embodiment of a pneumatic vehicle tire of a commercial vehicle with a five-degree bead seat, the height of radial extent H_{F1} from the vertex X of the rim of the first turned-back portion and the height of radial extent H_{F2} from the vertex X of the rim of the second turned-back portion are likewise governed by: H_{F1}>H_{I}, H_{F1}<H_{A} and H_{F2}<H_{U}. For example, H_{F2} is formed such that (10 mm)≦H_{F2}≦(30 mm). H_{F1} may be for example up to 55 mm.

The bead core 6 of the aforementioned exemplary embodiments is for example—as shown in the presented exemplary embodiments according to FIG. 2 to FIG. 15—a bead core 6 with a substantially pentagonal cross section. In another embodiment, the bead core 6 is—as in the presented exemplary embodiments according to FIG. 1, FIG. 16 to FIG. 19—a bead core with a substantially hexagonal cross section with for example—as represented in FIG. 1—partly flattened corners. In a further alternative embodiment (not represented), the bead core 6 is formed in alternative cross-sectional forms of a known type, for example in a round, oval, elliptical cross-sectional form or other polygonal cross-sectional form that is suitable for forming a bead core.

Even if the form with the bead reinforcing ply 10 and the bead reinforcing strip 12 has so far only been presented and described in connection with pneumatic tires for commercial vehicles, further exemplary embodiments contain an analogous form of this type also in the case of other pneumatic vehicle tires, such as for example pneumatic vehicle tires for passenger cars, motorcycles, scooters, earthmoving machines, tractors or aircraft tires.

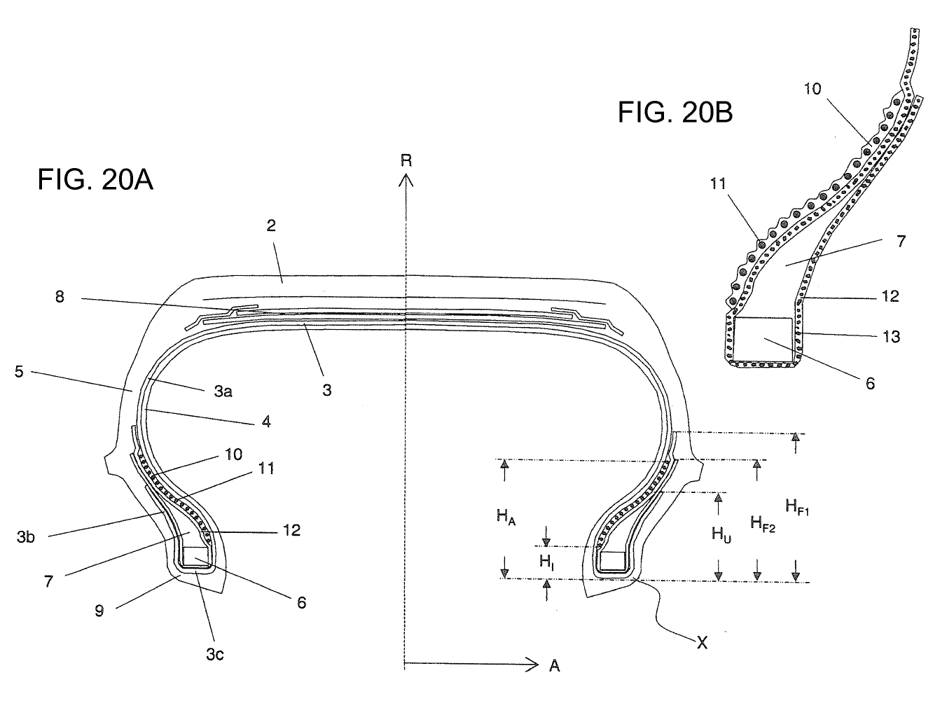

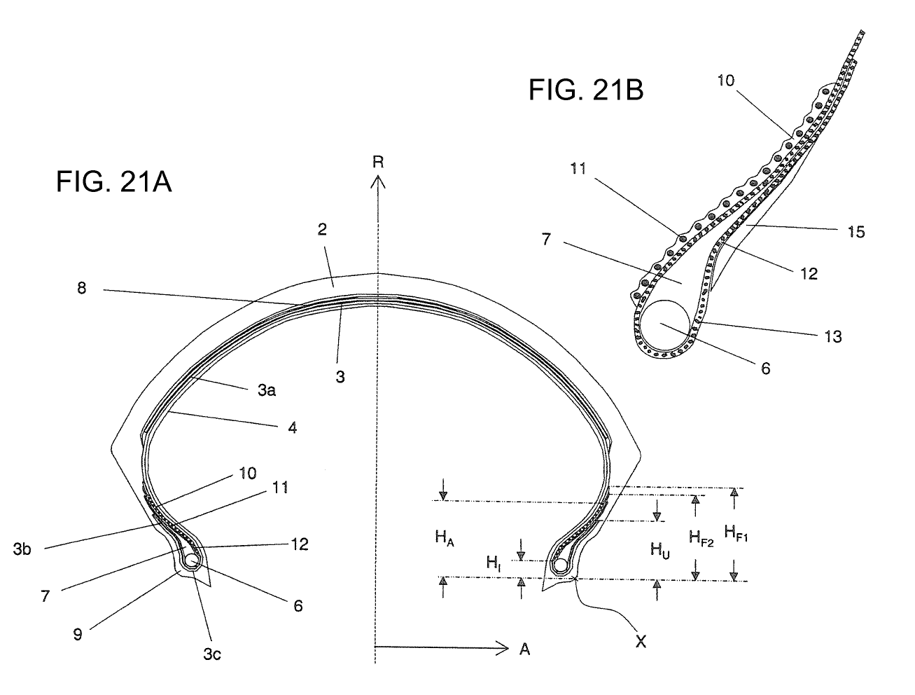

This is represented by way of example in FIGS. 20A and 20B in the example of the pneumatic vehicle tires for passenger cars and in FIGS. 21A and 21B in the example of pneumatic vehicle tires for motorcycles and scooters.

FIG. 20A shows a pneumatic vehicle tire for passenger cars for a well-base rim in a non-loaded operating state, fitted on a corresponding rim (not represented). FIG. 20A schematically shows the pneumatic vehicle tire for passenger cars in cross section, the rim shoulder also having a seat in the bead region with an inclination to the axial A of 5°. The designations of the components are identical here to those in FIG. 1. The basic construction of the pneumatic vehicle tire corresponds to the construction already explained in connection with FIGS. 1 to 19 and the various exemplary embodiments presented in connection therewith.

A tread rubber 2, a carcass inlay 3, a multi-ply breaker belt 8 with a belt edge bandage, an inner layer 4, two sidewalls 5 and a bead core 6 on each sidewall, a bead filler 7 and a bead strip 9 are represented as some of the components of the pneumatic vehicle tire for passenger cars. The carcass inlay 3 has, in particular, textile cords as strengthening supports, which extend at right angles or substantially at right angles to the circumferential direction of the tire, and consequently in the radial direction R of the tire. The bead core 6 is formed of steel cords, the core profile 7, arranged radially outside the bead core 6 and seated on the latter, consists of a rubber mixture with a high modulus of elasticity and may be embodied in a one-part form—as represented—or else in a multi-part form—as not represented—and consequently consist of rubber mixtures of different moduli of elasticity.

As represented in FIG. 20A, the carcass inlay 3 extends with its main part 3a from the breaker belt radially inward through the sidewall along the axially inner side of the bead filler 7 and the bead core 6, is led axially outward around the bead core 6 to form an intermediate portion 3c on the radially inner side of the bead core 6 and wrapped radially outward around the bead core 6, and extends with its turned-back portion 3b on the axial outer side of the bead core 6 and of the bead filler 7, in direct contact with the bead filler 7, to a radial distance H_{U} from the vertex X of the rim.

On the axial inner side of the bead filler 7, a bead reinforcing ply 10 is formed between the bead filler 7 and the main part 3a the carcass 3. The bead reinforcing ply 10 extends in this case from a radially inner position at the radial distance H_{I} from the vertex X of the rim to a radially outer position at the radial distance H_{A} from the vertex X of the rim. The bead reinforcing ply 10 is formed by a continuous strengthening support 11, which is made to extend in the circumferential direction of the entire tire, is embedded in a rubber mixture and wound up spirally so as to extend from the inside in a radial sense, beginning at the radial height H_{I}, radially outward to the radial height H_{A}. The bead reinforcing ply 10 is in this case in direct contact along its radial extent with the main part 3a of the carcass inlay 3.

As represented in FIG. 20A, formed radially inside the bead core 6 also in this embodiment is at least one further bead reinforcing strip 12, which is made to extend over the entire circumference of the vehicle tire, extends in the axial direction over the entire axial extent of the bead core 6 and is respectively turned back radially outward on both axial outer sides of the bead core 6, the first turned-back portion extending to a height of radial extent H_{F1} from the vertex X of the rim and the second turned-back portion extending to a height of radial extent H_{F2} from the vertex X of the rim. The dimensions H_{F2} and H_{U} are chosen for example such that H_{F1}≧H_{F2}>H_{U}. H_{A} is chosen for example such that H_{A}<H_{F1} and, in the exemplary embodiment represented, also such that H_{A}<H_{F2}.

The bead reinforcing strip 12 is in this case formed so as to extend with its first turned-back portion, seen in the radially inward direction, from the height of radial extent H_{F1} from the vertex X of the rim between the main part 3a of the carcass 3 and the sidewall rubber 5 to the height of radial extent H_{F2} from the vertex X of the rim, from there further to the height of radial extent H_{A} from the vertex X of the rim between the main part 3a of the carcass and the second turned-back portion of the bead reinforcing strip 12, in direct contact with the main part 3a of the carcass and with the second turned-back portion of the bead reinforcing strip 12, from there further to the height of radial extent H_{I} from the vertex X of the rim between the bead reinforcing ply 10 and the bead filler 7, in direct contact with the bead filler 7 and with the bead reinforcing ply 10, and formed radially inside the height of radial extent H_{I} from the vertex X of the rim and on the radially inner side of the bead core 6, in direct contact with the bead core 6 and with the carcass, so as to be placed snugly around the bead core 6, and formed on the axial outer side of the bead core 6 so as to extend radially outward to the height of radial extent H_{U} from the vertex X of the rim between the turned-back carcass portion 3b and the bead filler 7, in direct contact with the turned-back carcass portion 3b and with the bead filler 7, and following that to the height of radial extent H_{F2} from the vertex X of the rim between the sidewall rubber 5 and the first turned-back portion of the bead reinforcing strip 12, in direct contact with the first turned-back portion of the bead reinforcing strip 12.

FIG. 20B shows a component that is prefabricated from the bead core 6, the core profile 7, the bead reinforcing strip 12 with the strengthening support 13 and the bead reinforcing ply 10 with the strengthening support 11 and is used in a modular manner in the manufacturing process of the pneumatic vehicle tire.

As specified in connection with the embodiments presented or explained in connection with pneumatic tires of commercial vehicles, the bead reinforcing strip 12 is formed by textile strengthening supports 13 of a known type.

FIG. 21A shows a pneumatic vehicle tire for motorcycles or scooters for a well-base rim in a non-loaded operating state, fitted on a corresponding rim (not represented). FIG. 21A schematically shows the pneumatic vehicle tire for motorcycles or scooters in cross section. The designations of the components are identical here to those in FIG. 1. The basic construction of the pneumatic vehicle tire corresponds to the construction already explained in connection with FIGS. 1 to 20 and the various exemplary embodiments presented in connection therewith. A tread rubber 2, a carcass inlay 3, a multi-ply breaker belt 8, a single-ply inner layer 4, two sidewalls 5 and a bead core 6 on each sidewall, a bead filler 7 and a bead strip 9 are represented as some of the components of the pneumatic vehicle tire for passenger cars. The carcass inlay 3 has, in particular, textile cords as strengthening supports, which extend at right angles or substantially at right angles to the circumferential direction of the tire, and consequently in the radial direction R of the tire. The bead core 6 is formed of steel cords or other suitable cords of a known type with high tensile strength, the core profile 7, arranged radially outside the bead core 6 and seated on the latter, consists of a rubber mixture with a high modulus of elasticity and may also be embodied in a one-part form—as represented—or else in a multi-part form—as not represented—and consequently consist of rubber mixtures of different moduli of elasticity.

As represented in FIG. 21A, the carcass inlay 3 extends with its main part 3a from the breaker belt radially inward through the sidewall along the axially inner side of the bead filler 7 and the bead core 6, is led axially outward around the bead core 6 to form an intermediate portion 3c on the radially inner side of the bead core 6 and wrapped radially outward around the bead core 6, and extends with its turned-back portion 3b on the axial outer side of the bead core 6 and of the bead filler 7 in direct contact with the bead filler 7 to a radial distance H_{U} from the vertex X of the rim.

On the axial inner side of the bead filler 7, a bead reinforcing ply 10 is formed between the bead filler 7 and the main part 3a of the carcass 3. The bead reinforcing ply 10 extends in this case from a radially inner position at the radial distance H_{I} from the vertex X of the rim to a radially outer position at the radial distance H_{A} from the vertex X of the rim. The bead reinforcing ply 10 is formed by a continuous strengthening support 11, which is made to extend in the circumferential direction over the entire tire, is embedded in a rubber mixture and wound up spirally so as to extend from the inside in a radial sense, beginning at the radial height H_{I}, radially outward to the radial height H_{A}. The bead reinforcing ply 10 is in this case in direct contact along its radial extent with the main part 3a of the carcass inlay 3.

As represented in FIG. 21A, formed radially inside the bead core 6 also in this embodiment is at least one further bead reinforcing strip 12, which is made to extend over the entire circumference of the vehicle tire, extends in the axial direction over the entire axial extent of the bead core 6 and is respectively turned back radially outward on both axial outer sides of the bead core 6, the first turned-back portion extending to a height of radial extent H_{F1} from the vertex X of the rim and the second turned-back portion extending to a height of radial extent H_{F2} from the vertex X of the rim. The dimensions H_{F2} and Hu are chosen for example such that H_{F1}≧H_{F2}>H_{U}. H_{A} is chosen for example such that H_{A}<H_{F1} and, in the exemplary embodiment represented, also such that H_{A}<H_{F2}.

The bead reinforcing strip 12 is in this case formed so as to extend with its first turned-back portion, seen in the radially inward direction, from the height of radial extent H_{F1} from the vertex X of the rim between the main part 3a of the carcass 3 and the sidewall rubber 5 to the height of radial extent H_{F2} from the vertex X of the rim, from there further to the height of radial extent H_{A} from the vertex X of the rim between the main part 3a of the carcass and the second turned-back portion of the bead reinforcing strip 12, in direct contact with the main part 3a of the carcass and with the second turned-back portion of the bead reinforcing strip 12, from there further to the height of radial extent H_{I} from the vertex X of the rim between the bead reinforcing ply 10 and the bead filler 7, in direct contact with the bead filler 7 and with the bead reinforcing ply 10, and formed radially inside the height of radial extent H_{I} from the vertex X of the rim and on the radially inner side of the bead core 6, in direct contact with the bead core 6 and with the carcass, so as to be placed snugly around the bead core 6, and formed on the axial outer side of the bead core 6 so as to extend radially outward to the height of radial extent H_{U} from the vertex X of the rim between the turned-back carcass portion 3b and the bead filler 7, in direct contact with the turned-back carcass portion 3b and with the bead filler 7, and following that to the height of radial extent H_{F2} from the vertex X of the rim between the sidewall rubber 5 and the first turned-back portion of the bead reinforcing strip 12, in direct contact with the first turned-back portion of the bead reinforcing strip 12.

FIG. 21B shows a component that is prefabricated from the bead core 6, the core profile 7, the bead reinforcing strip 12 with the strengthening support 13, and additional rubber profile 15 and the bead reinforcing ply 10 with the strengthening support 11 and is used in a modular manner in the manufacturing process of the pneumatic vehicle tire.

As specified in connection with the embodiments presented or explained in connection with pneumatic tires of commercial vehicles, the bead reinforcing strip 12 is formed by textile strengthening supports 13 of a known type.

1. A vehicle tire, comprising:
a tread rubber;
a bead region formed radially inside said tread rubber and in a fastening region, said bead region having a bead core for securing the vehicle tire on a correspondingly formed seat of a rim, a bead filler formed radially outside said bead core, and a bead reinforcing ply extending over a circumference of the vehicle tire and being formed with at least one strengthening support disposed such that said strengthening support is wound in a circumferential direction, formed spirally from an inside outward in a radial sense; and
at least one further bead reinforcing strip formed radially inside said bead core, said further bead reinforcing strip extending in an axial direction over an entire axial extent of said bead core and is respectively turned back radially outward on both axial outer sides of said bead core, said further bead reinforcing strip having a first turned-back portion extending to a height of radial extent H_{F1} from a vertex X of the rim and a second turned-back portion extending to a height of radial extent H_{F2} from the vertex X of the rim.

2. The vehicle tire according to claim 1, wherein both said height of radial extent H_{F1} from the vertex X of the rim and said height of radial extent H_{F2} from the vertex X of the rim being formed radially outside a radial distance of a radially outer extent of said bead core from the vertex X of the rim.

3. The vehicle tire according to the claim 1, wherein said first turned-back portion is formed axially adjacent said bead reinforcing ply.

4. The vehicle tire according to claim 3, wherein said first turned-back portion is formed in direct contact with said bead reinforcing ply.

5. The vehicle tire according to claim 1, wherein said first turned-back portion is formed in direct contact with said bead core, at least radially inside said bead core.

6. The vehicle tire according to claim 1, wherein said first turned-back portion is formed in direct contact with said bead core and with said bead filler.

7. The vehicle tire according to claim 1, wherein said second turned-back portion is formed in direct contact with said bead core and with said bead filler.

8. The vehicle tire according to claim 1, wherein said first turned-back portion is disposed on an axial inner side of said bead core in the vehicle tire.

9. The vehicle tire according to claim 1, wherein said first turned-back portion is formed between said bead reinforcing ply and said bead core.

10. The vehicle tire according to claim 1, wherein said bead reinforcing ply is formed between said first turned-back portion and said bead core.

11. The vehicle tire according to claim 1, wherein:
said further bead reinforcing strip includes a first reinforcing strip having a first turned-back portion and a second reinforcing strip having a first turned-back portion; and
said bead reinforcing ply is formed between said first turned-back portion of said first reinforcing strip and said first turned-back portion of said second reinforcing strip.

12. The vehicle tire according to claim 1, wherein said further bead reinforcing strip is formed by a ply of strengthening supports embedded in rubber selected from the group consisting of unvulcanized rubber and vulcanized rubber.

13. The vehicle tire according to claim 12 wherein said strengthening supports are formed so as to extend at a helix angle of 35° to 55° in relation to a circumferential direction of the vehicle tire.

14. The vehicle tire according to claim 1, wherein said bead reinforcing ply is formed with said at least one strengthening support disposed such that said strengthening support is wound in a circumferential direction, formed spirally from an inside outward in a radial sense, said strengthening support is of a segmented form in a circumferential direction.

15. The vehicle tire according to claim 1, wherein said bead reinforcing ply is formed with said at least one strengthening support disposed such that said strengthening support is wound in a circumferential direction, formed spirally from an inside outward in a radial sense, said strengthening support formed continuously and uninterruptedly in a circumferential direction being wound in a first, radially inner region of an extent of a reinforcing material and said strengthening support is of a segmented form in the circumferential direction being wound in a second, radially outer region of the extent of said reinforcing material.

16. The vehicle tire according to claim 14, wherein said strengthening support of said bead reinforcing ply is a metallic strengthening support.

17. The vehicle tire according to claim 1, further comprising at least one carcass ply formed with parallel strengthening supports embedded in rubber selected from the group consisting of unvulcanized rubber material and vulcanized rubber material and wrapped around said bead core, said bead reinforcing strip also disposed between said carcass ply and said bead core.

18. The vehicle tire according to claim 17,
further comprising a tire sidewall; and
wherein said carcass ply has a main part extending radially inward in said tire sidewall between a tire shoulder and an radial inner side of said bead core and thereby formed in a radial region of extent of said bead core and of said bead filler such that said main part extends along an axial inner side of said bead core and of said bead filler, and said carcass ply being formed with a turned-back portion along an axial outer side of said bead core and of said bead filler such that said turned-back portion is made to extend radially outward.

19. The vehicle tire according to claim 17, wherein said turned-back portion of said carcass ending on a surface of said bead filler at a distance greater than zero from said main part of said carcass.

20. The vehicle tire according to claim 17, wherein said strengthening supports of said carcass ply are one of monofilaments and multifilaments of textile, a metallic material, and steel.

21. The vehicle tire according to claim 1, wherein the vehicle tire is a pneumatic vehicle tire.

22. The vehicle tire according to claim 1, wherein said further bead reinforcing strip extends over an entire circumference of the vehicle tire.

23. The vehicle tire according to claim 12, wherein said strengthening supports of said further bead reinforcing strip are textile strengthening supports.

24. The vehicle tire according to claim 17, wherein said at least one carcass ply is of a radial type of construction.
